(19) United States
(12) Patent Application Publication
(10) Pub. No.: US 2022/0325662 A1
(43) Pub. Date: Oct. 13, 2022

(54) HYBRID HYDROGEN-ELECTRIC AND HYDROGEN TURBINE ENGINE AND SYSTEM

(71) Applicant: ZeroAvia, Ltd., Cirencester (GB)

(72) Inventor: Valery MIFTAKHOV, San Carlos, CA (US)

(73) Assignee: ZeroAvia, Ltd., Cirencester (GB)

(21) Appl. No.: 17/657,359

(22) Filed: Mar. 31, 2022

Related U.S. Application Data
(60) Provisional application No. 63/170,046, filed on Apr. 2, 2021.

(51) Int. Cl. F02C 3/22; F02C 6/00

(52) U.S. Cl. CPC F02C 3/22; F02C 6/00; F05D 2260/20

(57) ABSTRACT

A hybrid hydrogen-electric and hydrogen turbine engine and system is disclosed. The hydrogen-electric system has an air inlet, a hydrogen fuel source, a fuel cell stack, and a motor assembly disposed in electrical communication with the fuel cell stack. The hydrogen turbine system has an air intake in fluid communication with the air inlet of the hydrogen-electric system, a combustion chamber in fluid communication with the air intake and the hydrogen fuel source of the hydrogen-electric system, the combustion chamber configured to mix air received from the air intake with hydrogen received from the hydrogen fuel source, and a turbine driven by energy received from the combustion chamber. The hydrogen-electric system and the hydrogen turbine system cooperate with one another to generate the output power of the hybrid hydrogen engine system.

### CROSS-REFERENCE TO RELATED APPLICATIONS (PROVISIONAL)

This application claims priority to and benefit of co-pending U.S. Provisional Patent Application No. 63/170,046 filed on Apr. 2, 2021, entitled “HYBRID HYDROGEN-ELECTRIC AND HYDROGEN TURBINE ENGINE AND SYSTEM” by Valery Miftakhov, and assigned to the assignee of the present application, the disclosure of which is hereby incorporated by reference in its entirety.

### FIELD OF THE INVENTION

Embodiments of the present technology relate generally to clean energy-based air propulsion systems, and more particularly, to integrated hydrogen-electric engines such as for aircraft transportation systems.

### BACKGROUND

Most issued pilot licenses are in the private pilot category. Moreover, the aircraft most often used in private aviation is the small single engine aircraft. These aircraft usually employ a single piston gasoline engine as the primary method of forward propulsion. Coincidentally, these small single engine aircraft contribute the highest number of safety infractions and accidents in general aviation. In case of failure of the single engine, the aircraft encounters a seriously hazardous condition and has to land immediately. If such event occurs over mountains terrain, at night, or in the Instrumental Meteorological Conditions (IMC), the outcome is often tragic.

Moreover, a traditional internal combustion aviation engine contains a large number of moving parts with a low level of integration and which operate under large mechanical and thermal stresses. This unnecessarily adds weight and volume to the aircraft, negatively affects reliability of components, significantly limits useful life of the engines, increases environmental pollution, and increases probability of failure per hour of operation. As a result, aircraft owners and operators incur frequent and extensive maintenance of their engines which adds a significant cost to the ownership and operation of traditionally-powered aircraft.

In the commercial aviation market, the high maintenance and fuel costs for the traditional turbine engines similarly increases the operating costs for the airlines and other types of operators. Additionally, the continued growth of fossil fuel aviation is increasingly contributing to the particulate pollution around the airports, increased reliance on fossil fuel extraction, as well as the growing climate change impacts. The highspeed exhaust gases of the traditional turbine engines contribute significantly to the extremely large noise footprint of the commercial aviation, especially in the densely populated areas.

In the surveillance and defense applications, the high engine and exhaust temperatures significantly hamper the ability of aircraft to avoid detection and therefore reduce the mission capabilities of the aircraft.

### BRIEF DESCRIPTION OF THE DRAWINGS

Aspects of the present invention are illustrated by way of example, and not by way of limitation, in the accompanying drawings, wherein:

FIG. 1 is a schematic view of an integrated hydrogen-electric engine system, in accordance with an embodiment.

FIG. 2 is a schematic view of a fuel cell of the integrated hydrogen-electric engine system of FIG. 1, in accordance with an embodiment.

FIG. 3 is a block diagram of a controller configured for use with the integrated hydrogen-electric engine system of FIG. 1, in accordance with an embodiment.

FIG. 4 is a schematic view of a hybrid hydrogen engine system including a hydrogen-electric system and a hydrogen turbine system, in accordance with an embodiment.

FIG. 5 is a side view of an aircraft powered by the hybrid hydrogen engine system of FIG. 4, in accordance with an embodiment.

The drawings referred to in this description should be understood as not being drawn to scale except if specifically noted.

### DESCRIPTION OF EMBODIMENTS

The detailed description set forth below in connection with the appended drawings is intended as a description of various embodiments of the present invention and is not intended to represent the only embodiments in which the present invention is to be practiced. Each embodiment described in this disclosure is provided merely as an example or illustration of the present invention, and should not necessarily be construed as preferred or advantageous over other embodiments. In some instances, well known methods, procedures, objects, and circuits have not been described in detail as not to unnecessarily obscure aspects of the present disclosure.

Hydrogen-electric engine systems are disclosed herein as an example use of the system for fuel cell management. However, it should be appreciated that in another embodiment, other systems with different types of fuel cells may be used in conjunction with or in place of one or more of the Hydrogen and/or electric engine systems.

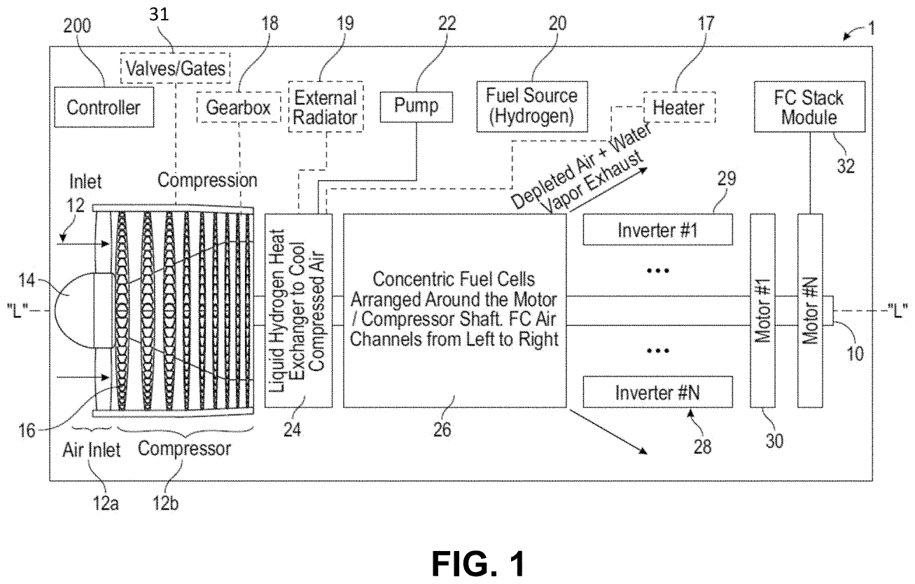

With reference now to FIG. 1, a block diagram of an integrated hydrogen-electric engine system 1 is shown in accordance with one embodiment. In one embodiment, integrated hydrogen-electric engine system 1 is utilized, for example, in a turboprop or turbofan system, to provide a streamlined, lightweight, power-dense, and efficient system. In general, integrated hydrogen-electric engine system 1 includes an elongated shaft 10 that defines a longitudinal axis “L” and extends through the entire powertrain of integrated hydrogen-electric engine system 1 to function as a common shaft for the various components of the powertrain. Elongated shaft 10 supports propulsor 14 (e.g., a fan or propeller) and a multi-stage air compressor system 12, a pump 22 in fluid communication with a fuel source (e.g., hydrogen), a heat exchanger 24 in fluid communication with air compressor system 12, a fuel cell stack 26 in fluid communication with heat exchanger 24, and a motor assembly 30 disposed in electrical communication with the fuel cell stack 26.

Air compressor system 12 of integrated hydrogen-electric engine system 1 includes an air inlet portion 12a at a distal end thereof and a compressor portion 12b that is disposed proximally of air inlet portion 12a for uninterrupted, axial delivery of airflow in the proximal direction. Compressor portion 12b supports a plurality of longitudinally spaced-apart rotatable compressor wheels 16 (e.g., multi-stage) that rotate in response to rotation of elongated shaft 10 for compressing air received through air inlet portion 12a for pushing the compressed air to a fuel cell stack 26 for conversion to electrical energy.

In one embodiment, the number of compressor wheels/stages 16 and/or diameter, longitudinal spacing, and/or configuration thereof can be modified as desired to change the amount of air supply, and the higher the power, the bigger the propulsor 14. These compressor wheels 16 can be implemented as axial or centrifugal compressor stages. Further, the compressor can have one or more bypass valves and/or wastegates 31 to regulate the pressure and flow of the air that enters the downstream fuel cell stack 26, as well as to manage the cold air supply to any auxiliary heat exchangers in the system.

Compressor system 12 can optionally be mechanically coupled to elongated shaft 10 via a gearbox 18 to change (increase and/or decrease) compressor turbine rotations per minute (RPM) and to change the airflow to fuel cell stack 26. For instance, gearbox 18 can be configured to enable the airflow, or portions thereof, to be exhausted for controlling a rate of airflow through the fuel cell stack 26, and thus, the output power.

Integrated hydrogen-electric engine system 1 further includes a gas management system such as a heat exchanger 24 disposed concentrically about elongated shaft 10 and configured to control thermal and/or humidity characteristics of the compressed air from air compressor system 12 for conditioning the compressed air before entering fuel cell stack 26. Integrated hydrogen-electric engine system 1 further also includes a fuel source 20 of fuel cryogenic (e.g., liquid hydrogen (LH2), or cold hydrogen gas) that is operatively coupled to heat exchanger 24 via a pump 22 configured to pump the fuel from fuel source 20 to heat exchanger 24 for conditioning compressed air. In particular, the fuel, while in the heat exchanger 24, becomes gasified because of heating (e.g., liquid hydrogen converts to gas) to take the heat out of the system.

In one embodiment, the hydrogen gas is heated in the heat exchanger 24 to a working temperature of the fuel cell stack 26, which also takes heat out of the compressed air, which results in control of flow through the heat exchanger 24. In one embodiment, a heater 17 can be coupled to or included with heat exchanger 24 to increase the heat as necessary, for instance, when running under a low power regime. Additionally, and/or alternatively, motor assembly 28 can be coupled to heat exchanger 24 for looping in the cooling/heating loops from motor assembly 28 as necessary. Such heating/cooling control can be managed, for instance, via controller 200 of integrated hydrogen-electric engine system 1. In one embodiment, fuel source 20 can be disposed in fluid communication with motor assembly 28 or any other suitable component to facilitate cooling of such components.

Pump 22 can also be coaxially supported on elongated shaft 10 for actuation thereof in response to rotation of elongated shaft 10. Heat exchanger 24 is configured to cool the compressed air received from air compressor system 12 with the assistance of the pumped liquid hydrogen.

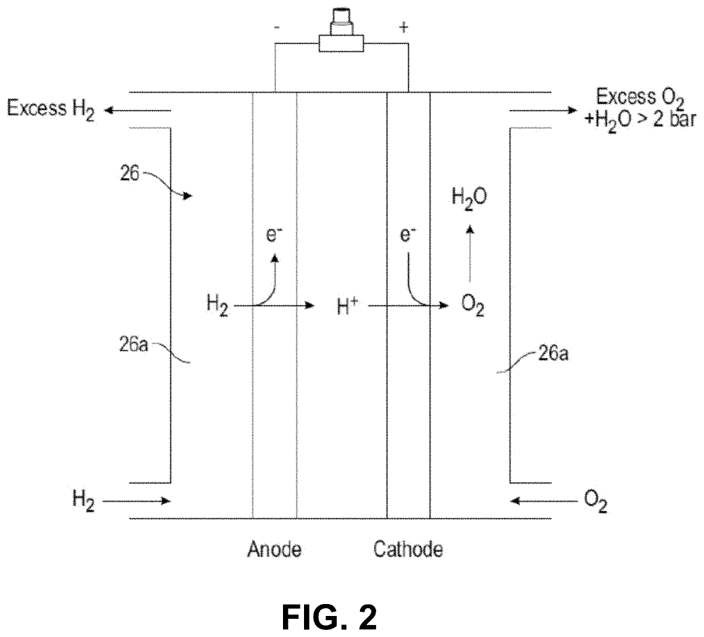

With reference also to FIG. 2, In one embodiment, integrated hydrogen-electric engine system 1 further includes an energy core in the form of a fuel cell stack 26, which may be circular, and is also coaxially supported on elongated shaft 10 (e.g., concentric) such that any air channels of fuel cell stack 26 may be oriented in parallel relation with elongated shaft 10 (e.g., horizontally or left-to-right). Fuel cell stack 26 may be in the form of a proton-exchange membrane fuel cell (PEMFC). The fuel cells of the fuel cell stack 26 are configured to convert chemical energy liberated during the electrochemical reaction of hydrogen and oxygen to electrical energy (e.g., direct current). Depleted air and water vapor are exhausted from fuel cell stack 26. The electrical energy generated from fuel cell stack 26 is then transmitted to the motor assembly, which is also coaxially/concentrically supported on elongated shaft 10.

In one embodiment, integrated hydrogen-electric engine system 1 may include any number of external radiators 19 for facilitating airflow and adding, for instance, additional cooling. Notably, fuel cell stack 26 can include liquid-cooled and/or air-cooled cell types so that cooling loads are integrated into heat exchanger 24 for reducing the total amount of external radiators needed in the system.

The motor assembly of integrated hydrogen-electric engine system 1 includes a plurality of inverters 28 and 29 configured to convert the direct current to alternating current for actuating one or more of a plurality of motors 30 in electrical communication with the inverters 28 and 29. The plurality of motors 30 are configured to drive (e.g., rotate) the elongated shaft 10 in response to the electrical energy received from fuel cell stack 26 for operating the components on the elongated shaft 10 as elongated shaft 10 rotates.

In one embodiment, one or more of the inverters 28 and 29 may be disposed between motors 30 (e.g., a pair of motors) to form a motor subassembly, although any suitable arrangement of motors 30 and inverters 28 and 29 may be provided. The motor assembly can include any number of motor subassemblies supported on elongated shaft 10 for redundancy and/or safety. In one embodiment, the motor assembly can include any number of fuel cell stack modules 32 configured to match the power of the motors 30 and the inverters 28 and 29 of the subassemblies. In this regard, for example, during service, the fuel cell stack modules 32 can be swapped in/out. Each fuel cell stack modules 32 can provide any power, such as 400 kw or any other suitable amount of power, such that when stacked together (e.g., 4 or 5 modules), total power can be about 2 Megawatts on the elongated shaft 10. In embodiments, motors 30 and inverters 28 and 29 can be coupled together and positioned to share the same thermal interface so a motor casing of the motors 30 is also an inverter heat sink so only a single cooling loop goes through the motor assembly for cooling the inverters 29 and the motors 30 at the same time. This reduces the number of cooling loops and therefore the complexity of the system.

Integrated hydrogen-electric engine system 1 further includes a controller 200 (e.g., a full authority digital engine (or electronics) control (e.g., a FADEC) for controlling the various embodiments of the integrated hydrogen-electric engine system 1 and/or other components of the aircraft system. For instance, controller 200 can be configured to manage a flow of liquid hydrogen, manage coolant liquids from the motor assembly, manage, for example, any dependent auxiliary heater for the liquid hydrogen, manage rates of hydrogen going into fuel cell stack 26, manage rates of heated/cooled compressed air, and/or various flows and/or power of integrated hydrogen-electric engine system 1.

In one embodiment, managing these thermal management components is designed to ensure the most efficient use of the various cooling and heating capacities of the respective gases and liquids to maximize the efficiency of the system and minimize the volume and weight of the same. For example, the cooling capacity of liquid hydrogen or cool hydrogen gas (post-gasification) can be effectively used to cool the hot compressor discharge air to ensure the correct temperature range in the fuel cell inlet. Further, the cooling liquid from the motor-inverter cooling loop could be integrated into the master heat exchanger and provide the additional heat required to gasify hydrogen and heat it to the working fuel cell temperature.

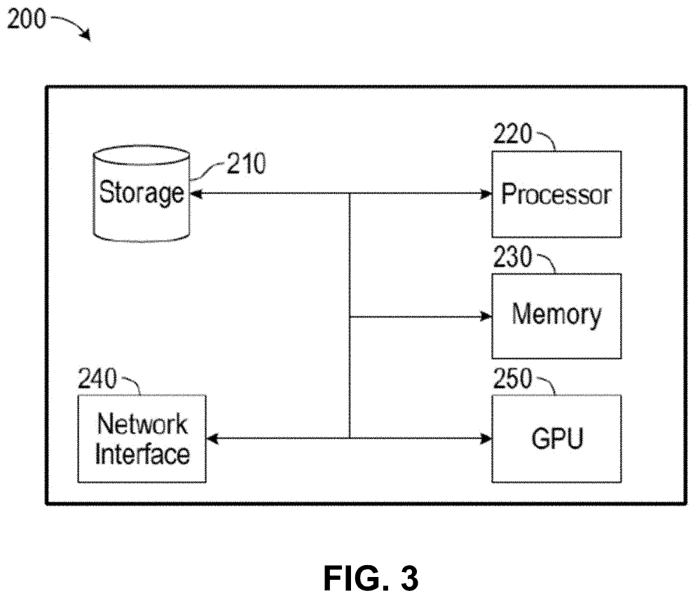

FIG. 3 illustrates a controller 200 in accordance with an embodiment. In one embodiment controller 200 includes a processor 220 coupled with a computer-readable storage medium or a memory 230. The computer-readable storage medium or memory 230 may be a volatile type of memory, e.g., RAM, or a non-volatile type memory, e.g., flash media, disk media, etc. In one embodiment, the processor 220 may be another type of processor such as, without limitation, a digital signal processor, a microprocessor, an ASIC, a graphics processing unit (GPU), a field-programmable gate array (FPGA), or a central processing unit (CPU). In one embodiment, network inference may also be accomplished in systems that have weights implemented as memristors, chemically, or other inference calculations, as opposed to processors.

In one embodiment, the memory 230 can be random access memory, read-only memory, magnetic disk memory, solid-state memory, optical disc memory, and/or another type of memory. In one embodiment, the memory 230 can be separate from the controller 200 and can communicate with the processor 220 through communication buses of a circuit board and/or through communication cables such as serial ATA cables or other types of cables. The memory 230 includes computer-readable instructions that are executable by the processor 220 to operate the controller 200. In one embodiment, the controller 200 may include a network interface 240 to communicate with other computers or to a server. A storage device 210 may be used for storing data.

The disclosed method may run on the controller 200 or on a user device, including, for example, on a mobile device, an IoT device, or a server system.

In one embodiment, controller 200 is configured to receive, among other data, the fuel supply status, aircraft location, and control, among other features, the pumps, motors, sensors, etc.

In one embodiment, or in different embodiments, the integrated hydrogen-electric engine system 1 can include any number and/or type of sensors, electrical components, and/or telemetry devices that are operatively coupled to controller 200 for facilitating the control, operation, and/or input/out of the various components of integrated hydrogen-electric engine system 1 for improving efficiencies and/or determining errors and/or failures of the various components.

For a more detailed description of components of similar hydrogen-electric engine systems, one or more components of which can used or modified for use with the structure of the present disclosure, reference can be made, for example, to U.S. patent application Ser. No. 16/950,735.

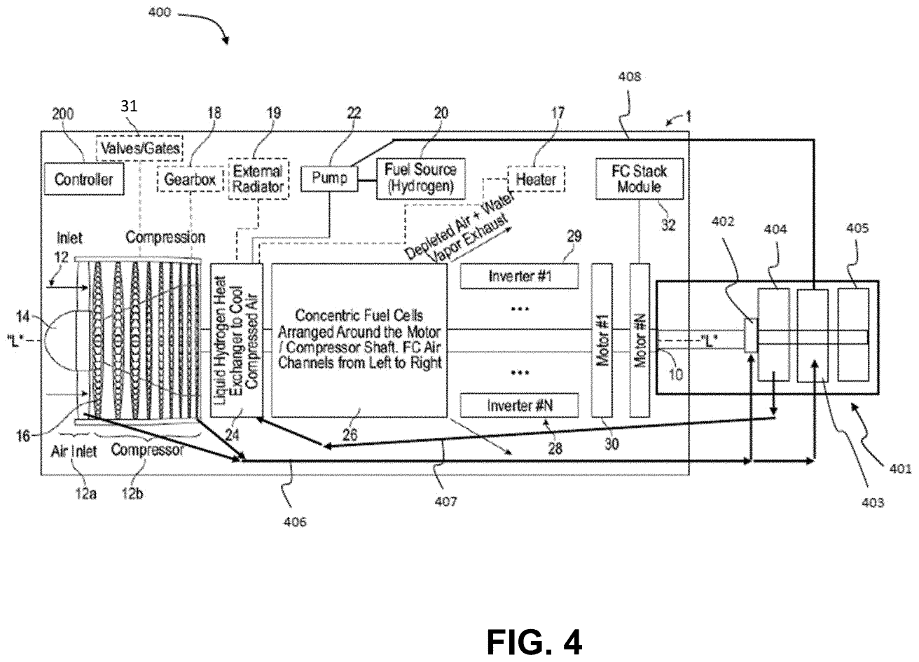

Referring to FIG. 4, a hybrid hydrogen engine system 400 including a hydrogen-electric system 1 and a hydrogen turbine system 401 is shown in accordance with an embodiment. Unless otherwise indicated below, the hydrogen-electric system 1 is substantially similar to the hydrogen-electric system 1 described above with reference to FIGS. 1-3.

As seen in FIG. 4, a hybrid hydrogen engine system 400 includes a hydrogen-electric system 1 and a hydrogen turbine system 401. In one embodiment, each of the hydrogen-electric system 1 and the hydrogen turbine system 401 can generate a portion of a total output power of the hybrid hydrogen engine system 400. The total output power may be dynamically adjusted according to a need of the device (e.g., an aircraft) being powered by the hybrid hydrogen engine system 400. For example, as the needs of the device change over time, the total power output by hybrid hydrogen engine system 400 may be adjusted by changing the individual output power of the hydrogen-electric system 1 and/or the hydrogen turbine system 401.

In one embodiment, each of the hydrogen-electric system 1 and the hydrogen turbine system 401 is positioned along the elongated shaft 10.

The hydrogen turbine system 401 includes a combustion chamber 403 in which compressed air received from at least one of the compressors described herein (e.g., the compressor 12b of the hydrogen-electric system 1 or a compressor 404 of the hydrogen turbine system 401) is mixed with hydrogen (e.g., hydrogen gas provided from the hydrogen fuel source 20). A turbine 405 is driven by energy produced by igniting the mixture of compressed air and hydrogen gas in combustion chamber 403. The turbine 405 may be used to power a device employing the hybrid hydrogen engine system 400 (e.g., the turbine 405 may produce at least a portion of the power used to drive an aircraft).

In one embodiment, the combustion chamber 403 may be in direct fluid communication with the compressor 12b of the hydrogen-electric system 1. Thus, in one embodiment, the combustion chamber 404 of the hydrogen turbine system 401 may be omitted, and a single compressor (12b) can be employed by both the hydrogen-electric system 1 and the hydrogen turbine system 401.

In one embodiment, the hydrogen turbine system 401 includes an air intake 402 in fluid communication with the air inlet 12a of the hydrogen-electric system 1. The combustion chamber 403 may be in fluid communication with the air intake 402 and the hydrogen fuel source 20 of the hydrogen-electric system 1. In one embodiment, the combustion chamber 403 receives compressed air from the compressor 404, and the compressor 404 provides compressed air to the heat exchanger 24. Thus, in one embodiment, the compressor 12b of the hydrogen-electric system 1 is omitted, and a single compressor (404) can be employed by both the hydrogen-electric system 1 and the hydrogen turbine system 401.

In one embodiment, utilizing a single compressor and/or omitting any redundant components included in each of the hydrogen-electric system 1 and the hydrogen turbine system 401, as described herein, reduces weight of the hybrid hydrogen engine system 400 and increases operating efficiency of the hybrid hydrogen engine system 400 (e.g., by reducing a required amount of hydrogen fuel to be carried).

In one embodiment, the compressor 404 of the hydrogen turbine system 401 is configured to regulate the pressure and flow of air that enters the heat exchanger 24 of the hydrogen-electric system 1. Thus, at least the external radiator 19, and/or the heater 17 can be omitted from the hydrogen-electric system 1 in hybrid system 400 to provide a simplified hybrid system 400.

Air flow line 406 connects air inlet 12a and/or compressor 12b of the hydrogen-electric system 1 with air intake 402 and/or combustion chamber 403 of the hydrogen turbine system 401. The air flow line 406 bypasses at least the heat exchanger 24 and fuel cell stack 26 of the hydrogen-electric system 1 to provide air flow (e.g., of compressed air) directly to the combustion chamber 403 of the hydrogen turbine system 401.

In one embodiment, air flow line 407 connects compressor 404 of the hydrogen turbine system 401 with the heat exchanger 24 of the hydrogen-electric system 1.

A fuel line 408 connects hydrogen fuel source 20 with the combustion chamber 403 of the hydrogen turbine system 401 (e.g., via pump 22).

In one embodiment, a controller (see, e.g., controller 200 described with reference to FIG. 3) is in communication with each of the hydrogen-electric system 1 and the hydrogen turbine system 401. The controller determines an overall output power of the hybrid hydrogen engine system 400, and the overall output power may be increased or decreased over time, such as based on the power needs of a device being driven by the hybrid hydrogen engine system 400.

In one embodiment, he controller determines an output power of the hydrogen-electric system 1 and an output power of the hydrogen turbine system 401. In one embodiment, the controller is configured to dynamically change the output power of the hydrogen-electric system 1 and the output power of the hydrogen turbine system 401 while the hybrid hydrogen engine system 400 is in operation to efficiently achieve a desired total output power. For example, the output power of the hydrogen-electric system 1 can be increased, by the controller, to 100% of the total output power of the hybrid hydrogen engine system 400 when a device being powered by the hybrid hydrogen engine system 400 can operate using the hydrogen-electric system 1 alone. The hydrogen turbine system 401 may be intermittently activated by the controller to provide additional power and to increase the total output power of the hybrid hydrogen engine system 400.

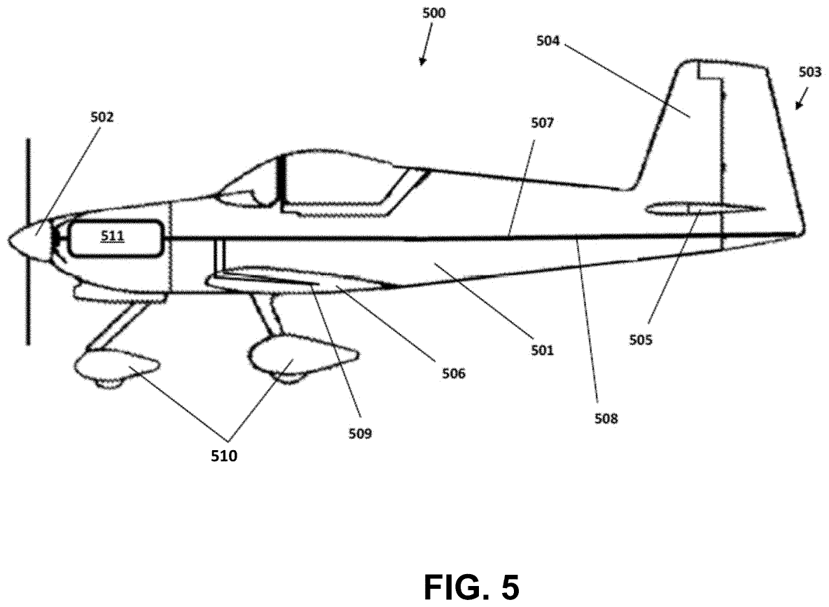

In one embodiment, the hybrid hydrogen engine system 400 is employed to power an aircraft (see, e.g., the aircraft 500 described below with reference to FIG. 5). The total output power of the hybrid hydrogen engine system 400 employed to power the aircraft can be generated by a combination of the power generated by the hydrogen-electric system 1 and/or the power generated by the hydrogen turbine system 401, and the amount of total output power of the hybrid hydrogen engine system 400 may be modified over time. Thus, the proportion of power generated by each of the hydrogen-electric system 1 and the hydrogen turbine system 401 can be adjusted during the course of a flight of the aircraft.

For example, during takeoff and climbing and/or descending and landing (when the required total output power of the hybrid hydrogen engine system 400 is relatively high), approximately 40% of the total output power of the hybrid hydrogen engine system 400 may be generated by the hydrogen-electric system 1 and approximately 60% of the total output power of the hybrid hydrogen engine system 400 may be generated by the hydrogen turbine system 401. For example, the hydrogen-electric system 1 may contribute from about 10% to about 60% of the total output power of the hybrid hydrogen engine system 400.

As cruising altitude is achieved (when the required total output power of the hybrid hydrogen engine system 400 is relatively low), the output power of the hydrogen turbine system 401 may be gradually reduced (e.g., may be reduced to an output power of 0), and the relative output power of the hydrogen-electric system 1 may be gradually increased (e.g., may be increased to 100% of the output power of the hybrid hydrogen engine system 400).

Therefore, during cruising, the aircraft can be powered entirely by the hydrogen-electric system 1, and the total output power of the hybrid hydrogen engine system may be maintained at a reduced level. This allows for the aircraft to operate at maximum hydrogen burning efficiency, thus reducing an amount of hydrogen fuel that is carried or consumed during a flight, while also providing maximum power output for takeoff, climbing, descending and landing.

Referring now to FIG. 5, a hydrogen-powered aircraft 500 is shown in accordance with an embodiment. In one embodiment, hydrogen-powered aircraft 500 is a turboprop aircraft. In another embodiment, hydrogen-powered aircraft 500 is another suitable aircraft configurations other than a turboprop (or more specifically a single engine turboprop). Aircraft 500 generally includes a fuselage 501, a propulsor 502 (e.g., a propeller) disposed at a forward end of fuselage 501, a tail 503 disposed at a rear end of fuselage 501 and including a vertical stabilizer 504 and a pair of horizontal stabilizers 505 extending outwardly from either side of tail 503, a pair of wings 506 extending outwardly from either side of fuselage 501, an exhaust system 507 including a fuselage portion 508 and/or a wing portion 509, a pair of wheel assemblies 510, and a hydrogen fuel cell-powered electric engine system 511. The aircraft 500 may be powered by a hydrogen engine system described with reference to FIGS. 1-4.

It should be understood the disclosed structure can include any suitable mechanical, electrical, and/or chemical components for operating the disclosed system or components thereof. For instance, such electrical components can include, for example, any suitable electrical and/or electromechanical and/or electrochemical circuitry, which may include or be coupled to one or more printed circuit boards. As appreciated, the disclosed computing devices and/or server can include, for example, a “controller,” “processor,” “digital processing device” and like terms, and which are used to indicate a microprocessor or central processing unit (CPU).

In one embodiment, the CPU is the electronic circuitry within a computer that carries out the instructions of a computer program by performing the basic arithmetic, logical, control and input/output (I/O) operations specified by the instructions, and by way of non-limiting examples, include server computers. In one embodiment, the controller includes an operating system configured to perform executable instructions. The operating system is, for example, software, including programs and data, which manages hardware of the disclosed apparatus and provides services for execution of applications for use with the disclosed apparatus. Those of skill in the art will recognize that suitable server operating systems include, by way of non-limiting examples, FreeBSD, OpenBSD, NetBSD®, Linux, Apple® Mac OS X Server®, Oracle® Solaris®, Windows Server®, and Novell® NetWare®. In one embodiment, the operating system is provided by cloud computing.

In one embodiment, the term “controller” may be used to indicate a device that controls the transfer of data from a computer or computing device to a peripheral or separate device and vice versa, and/or a mechanical and/or electromechanical device (e.g., a lever, knob, etc.) that mechanically operates and/or actuates a peripheral or separate device.

In one embodiment, the controller includes a storage and/or memory device. The storage and/or memory device is one or more physical apparatus used to store data or programs on a temporary or permanent basis. In one embodiment, the controller includes volatile memory and requires power to maintain stored information. In one embodiment, the controller includes non-volatile memory and retains stored information when it is not powered. In one embodiment, the non-volatile memory includes flash memory. In one embodiment, the non-volatile memory includes dynamic random-access memory (DRAM). In one embodiment, the non-volatile memory includes ferroelectric random-access memory (FRAM). In one embodiment, the non-volatile memory includes phase-change random access memory (PRAM). In one embodiment, the controller is a storage device including, by way of non-limiting examples, CD-ROMs, DVDs, flash memory devices, magnetic disk drives, magnetic tapes drives, optical disk drives, and cloud-computing-based storage. In one embodiment, the storage and/or memory device is a combination of devices such as those disclosed herein.

In one embodiment, the memory can be random access memory, read-only memory, magnetic disk memory, solid state memory, optical disc memory, and/or another type of memory. In one embodiment, the memory can be separate from the controller and can communicate with the processor through communication buses of a circuit board and/or through communication cables such as serial ATA cables or other types of cables. The memory includes computer-readable instructions that are executable by the processor to operate the controller. In one embodiment, the controller may include a wireless network interface to communicate with other computers or a server. In one embodiment, a storage device may be used for storing data. In one embodiment, the processor may be, for example, without limitation, a digital signal processor, a microprocessor, an ASIC, a graphics processing unit (“GPU”), field-programmable gate array (“FPGA”), or a central processing unit (“CPU”).

The memory stores suitable instructions, to be executed by the processor, for receiving the sensed data (e.g., sensed data from GPS, camera, etc. sensors), accessing storage device of the controller, generating a raw image based on the sensed data, comparing the raw image to a calibration data set, identifying an object based on the raw image compared to the calibration data set, transmitting object data to a ground-based post-processing unit, and displaying the object data to a graphic user interface. Although illustrated as part of the disclosed structure, in one embodiment, a controller may be remote from the disclosed structure (e.g., on a remote server), and accessible by the disclosed structure via a wired or wireless connection. In one embodiment where the controller is remote, it may be accessible by, and coupled with, multiple structures and/or components of the disclosed system.

The term “application” may include a computer program designed to perform particular functions, tasks, or activities for the benefit of a user. Application may refer to, for example, software running locally or remotely, as a standalone program or in a web browser, or other software which would be understood by one skilled in the art to be an application. An application may run on the disclosed controllers or on a user device, including for example, on a mobile device, an IoT device, or a server system.

In one embodiment, the controller includes a display to send visual information to a user. In one embodiment, the display is a cathode ray tube (CRT). In one embodiment, the display is a liquid crystal display (LCD). In one embodiment, the display is a thin film transistor liquid crystal display (TFT-LCD). In one embodiment, the display is an organic light-emitting diode (OLED) display. In one embodiment, on OLED display is a passive-matrix OLED (PMOLED) or active-matrix OLED (AMOLED) display. In one embodiment, the display is a plasma display. In one embodiment, the display is a video projector. In one embodiment, the display is interactive (e.g., having a touch screen or a sensor such as a camera, a 3D sensor, a LiDAR, a radar, etc.) that can detect user interactions/gestures/responses and the like. In one embodiment, the display is a combination of devices such as those disclosed herein.

The controller may include or be coupled to a server and/or a network. As used herein, the term “server” includes “computer server,” “central server,” “main server,” and like terms to indicate a computer or device on a network that manages the disclosed apparatus, components thereof, and/or resources thereof. As used herein, the term “network” can include any network technology including, for instance, a cellular data network, a wired network, a fiber-optic network, a satellite network, and/or an IEEE 802.11a/b/g/n/ac wireless network, among others.

In one embodiment, the controller can be coupled to a mesh network. As used herein, a “mesh network” is a network topology in which each node relays data for the network. In general, mesh nodes cooperate in the distribution of data in the network. It can be applied to both wired and wireless networks. Wireless mesh networks can be considered a type of “Wireless ad hoc” network. Thus, wireless mesh networks are closely related to Mobile ad hoc networks (MANETs). Although MANETs are not restricted to a specific mesh network topology, Wireless ad hoc networks or MANETs can take any form of network topology. Mesh networks can relay messages using either a flooding technique or a routing technique. With routing, the message is propagated along a path by hopping from node to node until it reaches its destination. To ensure that all its paths are available, the network must allow for continuous connections and must reconfigure itself around broken paths, using self-healing algorithms such as Shortest Path Bridging. Self-healing allows a routing-based network to operate when a node breaks down or when a connection becomes unreliable. As a result, the network is typically quite reliable, as there is often more than one path between a source and a destination in the network. This concept can also apply to wired networks and to software interaction. A mesh network whose nodes are all coupled with each other is a fully connected network.

In one embodiment, the controller may include one or more modules. As used herein, the term “module” and like terms are used to indicate a self-contained hardware component of the central server, which in turn includes software modules. In software, a module is a part of a program. Programs are composed of one or more independently developed modules that are not combined until the program is linked. A single module can contain one or several routines or sections of programs that perform a particular task.

As used herein, the controller includes software modules for managing various functions of the disclosed system or components thereof.

The disclosed structure may also utilize one or more controllers to receive various information and transform the received information to generate an output. The controller may include any type of computing device, computational circuit, or any type of processor or processing circuit capable of executing a series of instructions that are stored in memory. The controller may include multiple processors and/or multicore central processing units (CPUs) and may include any type of processor, such as a microprocessor, digital signal processor, microcontroller, programmable logic device (PLD), field programmable gate array (FPGA), or the like. The controller may also include a memory to store data and/or instructions that, when executed by the one or more processors, cause the one or more processors to perform one or more methods and/or algorithms.

Any of the herein described methods, programs, algorithms, or codes may be converted to, or expressed in, a programming language or computer program. The terms “programming language” and “computer program,” as used herein, each include any language used to specify instructions to a computer, and include (but is not limited to) the following languages and their derivatives: Assembler, Basic, Batch files, BCPL, C, C+, C++, Delphi, Fortran, Java, JavaScript, machine code, operating system command languages, Pascal, Perl, PL1, scripting languages, Visual Basic, metalanguages which themselves specify programs, and all first, second, third, fourth, fifth, or further generation computer languages. Also included are database and other data schemas, and any other meta-languages. No distinction is made between languages which are interpreted, compiled, or use both compiled and interpreted approaches. No distinction is made between compiled and source versions of a program. Thus, reference to a program, where the programming language could exist in more than one state (such as source, compiled, object, or linked) is a reference to any and all such states. Reference to a program may encompass the actual instructions and/or the intent of those instructions.

The present technology may be described in the general context of computer-executable instructions, such as program modules, being executed by a computer. Generally, program modules include routines, programs, objects, components, data structures, etc., that perform particular tasks or implement particular abstract data types. The present technology may also be practiced in distributed computing environments where tasks are performed by remote processing devices that are linked through a communications network. In a distributed computing environment, program modules may be located in both local and remote computer-storage media including memory-storage devices.

The examples set forth herein were presented in order to best explain, to describe particular applications, and to thereby enable those skilled in the art to make and use embodiments of the described examples. However, those skilled in the art will recognize that the foregoing description and examples have been presented for the purposes of illustration and example only. The description as set forth is not intended to be exhaustive or to limit the embodiments to the precise form disclosed. Rather, the specific features and acts described above are disclosed as example forms of implementing the Claims.

Reference throughout this document to “one embodiment,” “certain embodiments,” “an embodiment,” “various embodiments,” “some embodiments,” “various embodiments”, or similar term, means that a particular feature, structure, or characteristic described in connection with that embodiment is included in at least one embodiment. Thus, the appearances of such phrases in various places throughout this specification are not necessarily all referring to the same embodiment. Furthermore, the particular features, structures, or characteristics of any embodiment may be combined in any suitable manner with one or more other features, structures, or characteristics of one or more other embodiments without limitation.

What is claimed is:

1. A system comprising:
a hydrogen-electric system, the hydrogen-electric system including:
an air inlet;
a hydrogen fuel source;
a fuel cell stack;
a heat exchanger in fluid communication with the hydrogen fuel source and the fuel cell stack; and
a motor assembly disposed in electrical communication with the fuel cell stack; and
a hydrogen turbine system, the hydrogen turbine system including:
an air intake in fluid communication with the air inlet of the hydrogen-electric system;
a combustion chamber in fluid communication with the air intake and the hydrogen fuel source of the hydrogen-electric system, the combustion chamber configured to mix air received from the air intake with hydrogen received from the hydrogen fuel source; and
a turbine driven by energy received from the combustion chamber,
wherein the hydrogen-electric system and the hydrogen turbine system are configured to cooperate with one another to generate output power of the hybrid hydrogen engine system, and wherein each of the hydrogen-electric system and the hydrogen turbine system is configured to generate at least a portion of the output power of the hybrid hydrogen engine system.

2. The system of claim 1, further including an elongated shaft supporting the air inlet, the fuel cell stack, and the heat exchanger.

3. The system of claim 1, wherein the motor assembly includes at least one motor that is disposed in coaxial alignment with an elongated shaft, the at least one motor actuatable to rotate the elongated shaft.

4. The system of claim 3, wherein rotation of the at least one motor causes the air inlet to compress air for transmission to the heat exchanger.

5. The system of claim 3, wherein the motor assembly includes at least one inverter disposed in electrical communication with the at least one motor and the fuel cell stack.

6. The system of claim 5, wherein the at least one inverter converts direct current from the fuel cell stack into alternating current that actuates the at least one motor.

7. The system of claim 1, further comprising a propulsor supported on a distal end of an elongated shaft.

8. The system of claim 1, wherein the air inlet includes a plurality of spaced-apart compressor wheels that rotate in response to rotation of an elongated shaft.

9. The system of claim 1, wherein the air inlet includes a compressor that is mechanically coupled to an elongated shaft via a gearbox.

10. The system of claim 1, further comprising a pump in fluid communication with the hydrogen fuel source and the heat exchanger, the pump configured to pump hydrogen from the hydrogen fuel source to the heat exchanger.

11. The system of claim 1, wherein the fuel cell stack is disposed concentrically about an elongated shaft.

12. The system of claim 1, further including a controller in communication with each of the hydrogen-electric system and the hydrogen turbine system, the controller configured to determine a first output power of the hydrogen-electric system and a second output power of the hydrogen turbine system.

13. The system of claim 12, wherein the controller is configured to dynamically change the first output power of the hydrogen-electric system and the second output power of the hydrogen turbine system while the hybrid hydrogen engine system is in operation.

14. The system of claim 13, wherein the first output power of the hydrogen-electric system can be increased, by the controller, to 100% of a total output power of the hybrid hydrogen engine system.

15. The system of claim 1, wherein the hydrogen-electric system further includes a compressor, the compressor of the hydrogen-electric system in fluid communication with the combustion chamber of the hydrogen turbine system, the compressor configured to provide compressed air to the combustion chamber.

16. The system of claim 1, further including an elongated shaft, wherein each of the hydrogen-electric system and the hydrogen turbine system is positioned along the elongated shaft.

17. The system of claim 1, wherein the hydrogen turbine system further includes a compressor, the compressor of the hydrogen turbine system in fluid communication with the heat exchanger of the hydrogen-electric system, the compressor configured to provide compressed air to the heat exchanger.

18. The system of claim 17, wherein the compressor of the hydrogen turbine system is configured to regulate a pressure and flow of air that enters the heat exchanger of the hydrogen-electric system.

19. The system of claim 1, further including an airflow line extending between the air inlet of the hydrogen-electric system and the combustion chamber of the hydrogen turbine system.

20. The system of claim 19, wherein the airflow line bypasses the heat exchanger of the hydrogen-electric system.
